(19) United States
(12) Patent Application Publication
(10) Pub. No.: US 2019/0353487 A1
(43) Pub. Date: Nov. 21, 2019

(54) POSITIONING A TERMINAL DEVICE BASED ON DEEP LEARNING

(71) Applicant: BEIJING DIDI INFINITY TECHNOLOGY AND DEVELOPMENT CO., LTD., Beijing (CN)

(72) Inventors: Hailiang XU, Beijing (CN); Weihuan SHU, Beijing (CN)

(73) Assignee: BEIJING DIDI INFINITY TECHNOLOGY AND DEVELOPMENT CO., LTD., Beijing (CN)

(21) Appl. No.: 16/529,747

(22) Filed: Aug. 1, 2019

Related U.S. Application Data
(63) Continuation of application No. PCT/CN2017/098347, filed on Aug. 21, 2017.

(51) Int. Cl. G01C 21/28; G01S 19/48; G06N 3/08; G06K 9/62

(52) U.S. Cl. CPC G01C 21/28; G01S 19/48; H04W 84/12; G06K 9/6256; G06N 3/08

(57) ABSTRACT

Systems and methods for positioning a terminal device based on deep learning are disclosed. The method may include acquiring, by a positioning device, a set of preliminary positions associated with the terminal device, acquiring, by the positioning device, a base map corresponding to the preliminary positions, and determining, by the positioning device, a position of the terminal device using a neural network model based on the preliminary positions and the base map.

### CROSS-REFERENCE TO RELATED APPLICATIONS

The application is a continuation of International Application No. PCT/CN2017/098347, filed on Aug. 21, 2017, which is incorporated herein by reference in its entirety.

### TECHNICAL FIELD

The present disclosure relates to positioning a terminal device, and more particularly, to systems and methods for positioning a terminal device based on deep learning.

### BACKGROUND

Terminal devices may be positioned by Global Positioning System (GPS), base stations, Wireless Fidelity (WiFi) access points, or the like. The positioning accuracy for GPS can be three to five meters, the positioning accuracy for the base stations can be 100-300 meters, and the positioning accuracy for the WiFi access points can be 20-50 meters. However, GPS signals may be shielded by buildings in the city, and therefore the terminal devices may not be positioned by the GPS signals accurately. Furthermore, it usually takes a long time (e.g., more than 45 seconds) to initialize a GPS positioning module.

Thus, even in an outdoor environment, positioning a terminal device based on base stations, WiFi access points, or the like may be used. However, as discussed above, the accuracy for the positioning results is not satisfactory.

Embodiments of the disclosure provide improved systems and methods for accurately positioning a terminal device without GPS signals.

### SUMMARY

An aspect of the disclosure provides a computer-implemented method for positioning a terminal device, including: acquiring, by a positioning device, a set of preliminary positions associated with the terminal device; acquiring, by the positioning device, a base map corresponding to the preliminary positions; and determining, by the positioning device, a position of the terminal device using a neural network model based on the preliminary positions and the base map.

Another aspect of the disclosure provides a system for positioning a terminal device, including: a memory configured to store a neural network model; a communication interface in communication with the terminal device and a positioning server, the communication interface configured to: acquire a set of preliminary positions associated with the terminal device, acquire a base map corresponding to the preliminary positions; and a processor configured to determine a position of the terminal device using the neural network model based on the preliminary positions and the base map.

Yet another aspect of the disclosure provides a non-transitory computer-readable medium that stores a set of instructions, when executed by at least one processor of a positioning system, cause the positioning system to perform a method for positioning a terminal device, the method comprising: acquiring a set of preliminary positions associated with the terminal device; acquiring a base map corresponding to the preliminary positions; and determining a position of the terminal device using a neural network model based on the preliminary positions and the base map, wherein the neural network model is trained using at least one set of training parameters.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram illustrating an exemplary system for positioning a terminal device, according to some embodiments of the disclosure.

FIG. 2 is a block diagram of an exemplary system for positioning a terminal device, according to some embodiments of the disclosure.

FIG. 3 illustrates an exemplary benchmark position of an existing device and corresponding hypothetical positions associated with the existing device, according to some embodiments of the disclosure.

FIG. 4 illustrates of an exemplary training base map, according to some embodiments of the disclosure.

FIG. 5 illustrates an exemplary training image, according to some embodiments of the disclosure.

FIG. 6 illustrates an exemplary convolutional neural network, according to some embodiments of the disclosure.

FIG. 7 is a flowchart of an exemplary process for positioning a terminal device, according to some embodiments of the disclosure.

FIG. 8 is a flowchart of an exemplary process for positioning a terminal device using a neural network model, according to some embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

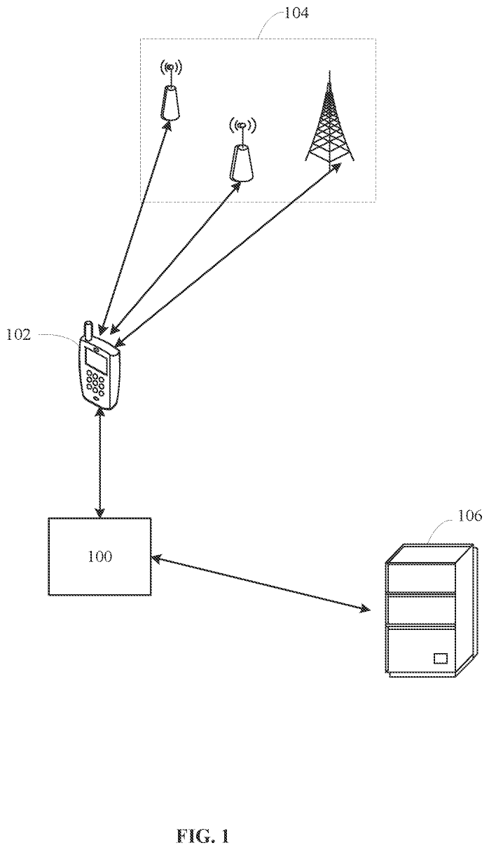

FIG. 1 is a schematic diagram illustrating an exemplary system for positioning a terminal device, according to some embodiments of the disclosure. System 100 may be a general server or a proprietary positioning device. Terminal devices 102 may include any electronic device that can scan access points (APs) 104 and communicate with system 100. For example, terminal devices 102 may include a smart phone, a laptop, a tablet, a wearable device, a drone, or the like.

As shown in FIG. 1, terminal devices 102 may scan nearby APs 104. APs 104 may include devices that transmit signals for communication with terminal devices. For example, APs 104 may include WiFi APs, a base station, Bluetooth APs, or the like. By scanning nearby APs 104, each terminal device 102 may generate an AP fingerprint. The AP fingerprint includes feature information associated with the scanned APs, such as identifications (e.g., names, MAC addresses, or the like), Received Signal Strength Indication (RSSI), Round Trip Time (RTT), or the like of APs 104.

The AP fingerprint may be transmitted to system 100 and used to acquire preliminary positions of APs 104 from a positioning server 106. Positioning server 106 may be an internal server of system 100 or an external server. Positioning server 106 may include a position database that stores preliminary positions of APs 104. The preliminary positions of an AP may be determined according to the GPS positions of terminal devices. For example, when a terminal device passes by the AP, the GPS position of the terminal device may be uploaded to positioning server 106 and assigned as a preliminary position of the AP. Thus, each AP 104 may include at least one preliminary position as more than one terminal devices may pass by the AP and upload GPS positions respectively. As explained, the preliminary positions of an AP are hypothetical, and may be referred to as hypothetical positions. It is contemplated that, the preliminary positions of the AP may include other positions, such as WiFi-determined positions, Bluetooth-determined positions, or the like.

Because the AP fingerprint only includes feature information associated with the APs that can be scanned by terminal device 102, the acquired hypothetical positions of APs 104 are associated with the position of terminal device 102. Thus, the association between the preliminary positions of APs 104 and the position of terminal device 102 may be used for positioning a terminal device.

Consistent with embodiments of the disclosure, system 100 may train a neural network model based on the preliminary positions of APs associated with existing devices in a training stage, and position a terminal device based on preliminary positions associated with the terminal device using the neural network model in a positioning stage.

In some embodiments, the neural network model is a convolutional neural network (CNN) model. CNN is a type of machine learning algorithm that can be trained by supervised learning. The architecture of a CNN model includes a stack of distinct layers that transform the input into the output. Examples of the different layers may include one or more convolutional layers, pooling or subsampling layers, fully connected layers, and/or final loss layers. Each layer may connect with at least one upstream layer and at least one downstream layer. The input may be considered as an input layer, and the output may be considered as the final output layer.

To increase the performance and learning capabilities of CNN models, the number of different layers can be selectively increased. The number of intermediate distinct layers from the input layer to the output layer can become very large, thereby increasing the complexity of the architecture of the CNN model. CNN models with a large number of intermediate layers are referred to as deep CNN models. For example, some deep CNN models may include more than 20 to 30 layers, and other deep CNN models may even include more than a few hundred layers. Examples of deep CNN models include AlexNet, VGGNet, GoogLeNet, ResNet, etc.

Embodiments of the disclosure employ the powerful learning capabilities of CNN models, and particularly deep CNN models, for positioning a terminal device based on preliminary positions of APs scanned by the terminal device.

As used herein, a CNN model used by embodiments of the disclosure may refer to any neural network model formulated, adapted, or modified based on a framework of convolutional neural network. For example, a CNN model according to embodiments of the disclosure may selectively include intermediate layers between the input and output layers, such as one or more deconvolution layers, and/or up-sampling or up-pooling layers.

As used herein, “training” a CNN model refers to determining one or more parameters of at least one layer in the CNN model. For example, a convolutional layer of a CNN model may include at least one filter or kernel. One or more parameters, such as kernel weights, size, shape, and structure, of the at least one filter may be determined by e.g., a backpropagation-based training process.

Consistent with the disclosed embodiments, to train a CNN model, the training process uses at least one set of training parameters. Each set of training parameters may include a set of feature signals and a supervised signal. As a non-limiting example, the feature signals may include hypothetical positions of APs scanned by an existing device, and the supervised signal may include a GPS position of the existing device. And a terminal device may be positioned accurately by the trained CNN model based on preliminary positions of APs scanned by the terminal device.

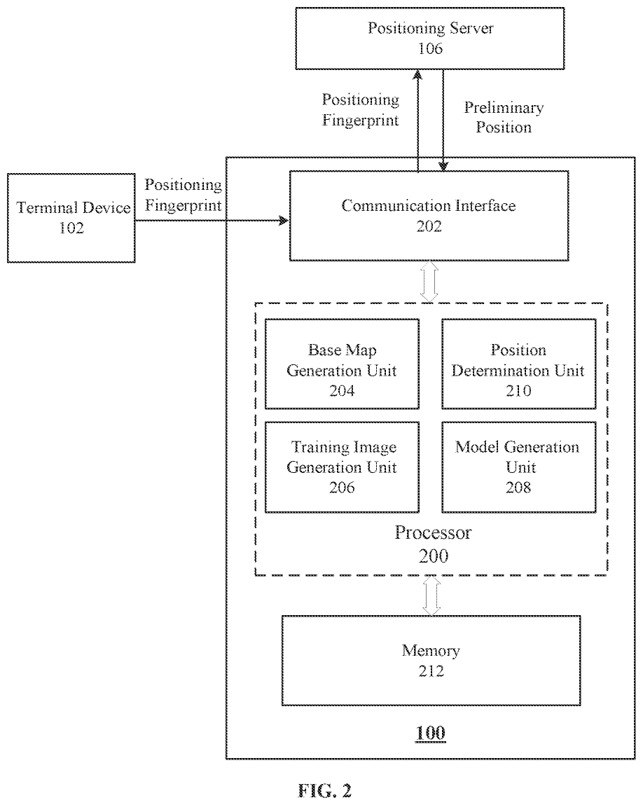

FIG. 2 is a block diagram of an exemplary system for positioning a terminal device, according to some embodiments of the disclosure.

As shown in FIG. 2, system 100 may include a communication interface 202, a processor 200 that includes a base map generation unit 204, a training image generation unit 206, a model generation unit 208, a position determination unit 210, and a memory 212. System 100 may include the above-mentioned components to perform the training stage. In some embodiments, system 100 may include more or less of the components shown in FIG. 2. For example, when a neural network model for positioning is pre-trained and provided, system 100 may not include training image generation unit 206 and model generation unit 208 anymore. It is contemplated that, the above components (and any corresponding sub-modules or sub-units) can be functional hardware units (e.g., portions of an integrated circuit) designed for use with other components or a part of a program (stored on a computer readable medium) that performs a particular function.

Communication interface 202 is in communication with terminal device 102 and positioning server 106, and may be configured to acquire an AP fingerprint generated by each of a plurality of terminal devices. For example, each terminal device 102 may generate an AP fingerprint by scanning APs 104 and transmit the AP fingerprint to system 100 via communication interface 202. After the AP fingerprints generated by the plurality of terminal devices are transmitted to system 100, communication interface 202 may send the AP fingerprints to positioning server 106, and receive preliminary positions of the scanned APs from positioning server 106. The preliminary positions of the scanned APs may be referred to as hypothetical positions in the training stage for clarity.

Furthermore, in the training stage, communication interface 202 may further receive a benchmark position of each terminal device 102. It is contemplated that, terminal devices in the training stage may be referred to as existing devices for clarity. The benchmark position of the existing device may be determined by a GPS positioning unit (not shown) embedded within the existing device.

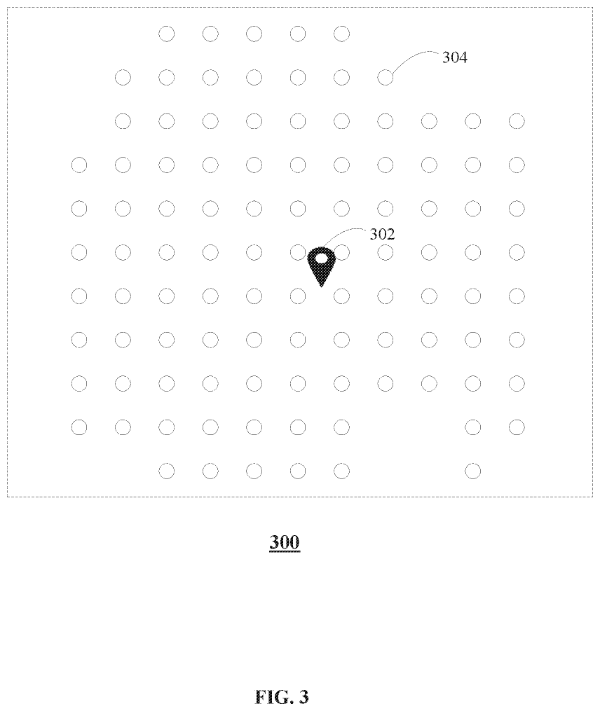

As explained, preliminary positions of a terminal device may be referred to as hypothetical positions. Therefore, in the training stage, communication interface 202 may receive benchmark positions and corresponding hypothetical positions associated with existing devices, for training a neural network model. FIG. 3 illustrates an exemplary benchmark position of an existing device and corresponding hypothetical positions associated with the existing device, according to some embodiments of the disclosure.

As shown in FIG. 3, in an area 300, a benchmark position 302 and corresponding hypothetical positions (e.g., a first hypothetical position 304) are distributed.

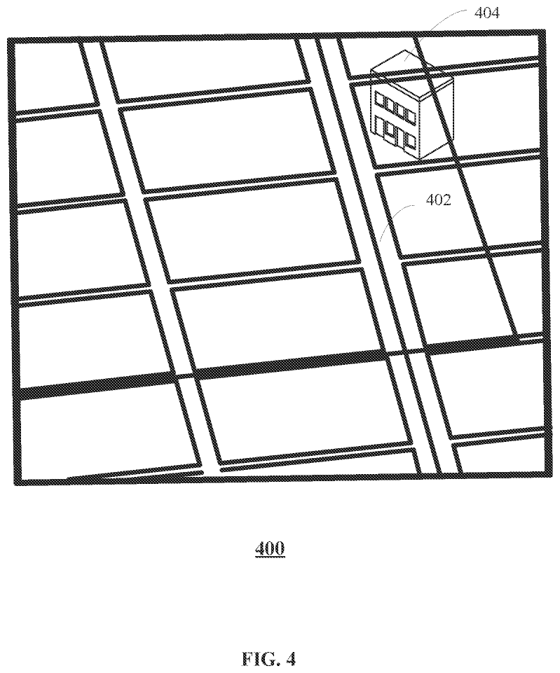

Base map generation unit 204 may acquire a base map according to the hypothetical positions of the scanned APs. Generally, positions of terminal devices carried by users in an outdoor environment present a known pattern. For example, a terminal device of a taxi driver oftentimes appears on a road, and terminal devices of passengers requesting the taxi service are oftentimes close to office buildings. Therefore, map information regarding roads, buildings, or the like may help with both of the training and positioning stages. The base map including the map information may be acquired from a map server (not shown). In one embodiment, base map generation unit 204 may determine an area that covers all hypothetical positions of the scanned APs, further determine coordinates of a pair of diagonal corners of the area, and acquire the base map based on the coordinates of the pair of diagonal corners from the map server. In another embodiment, base map generation unit 204 may aggregate the preliminary positions into a cluster, determine a center of the cluster, and acquire the base map having a predetermined length and a predetermined width based on the center from the map server. For example, the acquired base map may correspond to an area of 1,000 meters long and 1,000 meters wide. The base map may be referred to as a training base map in the training stage for clarity, and may be included in the training parameters. FIG. 4 illustrates of an exemplary training base map, according to some embodiments of the disclosure.

As shown in FIG. 4, training base map 400 includes one or more streets 402 and a building 404. The map information regarding streets 402 and building 404 may be further used for training the neural network model.

As discussed above, each existing device may provide a set of hypothetical positions of the APs scanned at a benchmark position, as each AP may have more than one hypothetical positions and several APs may be scanned. Thus, it is possible that, some of the hypothetical positions associated with the benchmark position may overlap. Thus, a position value may be assigned to each hypothetical position, and the position value may be incremented when the hypothetical positions overlap. For example, the position value may be incremented by one when a first hypothetical position of a first AP overlaps a second hypothetical position of a second AP. The position values corresponding to the hypothetical positions may also be included in the training parameters.

Due to the wide applications of the neural network model to images, system 100 may organize the training parameters in a form of an image. Thus, training image generation unit 206 may generate a training image based on coordinates of the hypothetical positions and respective position values. The hypothetical positions may be mapped to pixels of the training image, and the positions values of the hypothetical positions may be converted to pixel values of the pixels.

In some embodiments, the training image has a size of 100 pixels×100 pixels. Each pixel corresponds to an area of 0.0001 latitude×0.0001 longitude (that is, a square area of 10 meters×10 meters), and therefore the training image covers an overall area of 1,000 meters×1,000 meters. In other words, a position on earth indicated by latitude and longitude may be converted to a position on the training image. Furthermore, each pixel value may be between a range of 0 to 255. For example, when no hypothetical position exists within an area that corresponds to a pixel, the pixel value of the pixel is assigned with “0”, and when multiple hypothetical positions exist within the same area, the pixel value of the pixel is incremented accordingly.

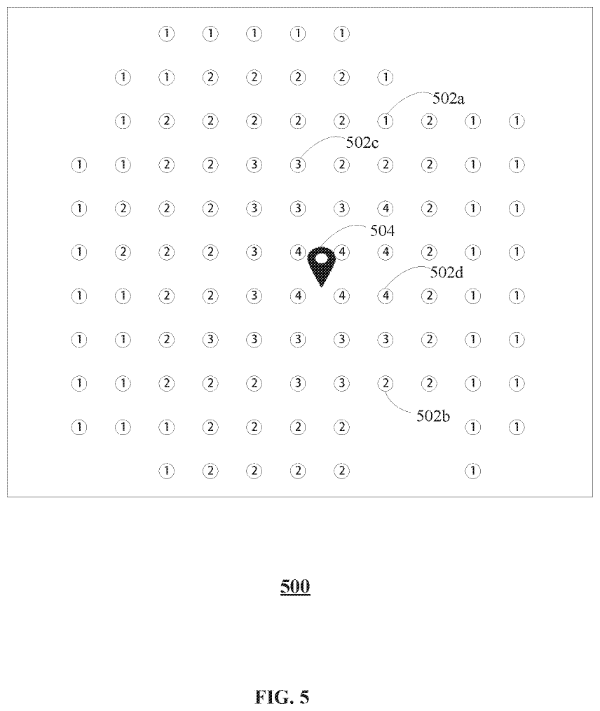

FIG. 5 illustrates an exemplary training image, according to some embodiments of the disclosure. As shown in FIG. 5, a training image 500 may include multiple pixels, including pixels 502a-502d. For example, a first pixel 502a has a pixel value of “1”, a second pixel 502b has a pixel value of “2”, a third pixel 502c has a pixel value of “3”, a fourth pixel 502d has a pixel value of “4”, and other pixels are initialized to a pixel value of “0”. Therefore, fourth pixel 502d has four hypothetical position of the APs overlapped thereon. Generally, pixels with higher pixel values are more closely distributed around the benchmark position. For example, as shown in FIG. 5, pixels with a pixel value of “4” are more closely distributed around a benchmark position 504 than other pixels. Therefore, pixel values may also assist system 100 to train the neural network model.

Besides the benchmark position of the existing device, the hypothetical positions associated with the exiting device, the position values of the hypothetical positions (i.e., the pixel values in the training image), and the training base map, the training parameters may further include identity information of the exiting device. The identity information may identify that the existing device is a passenger device or a driver device. Generally, the passenger device is more likely to appear near an office building while a passenger is waiting for a taxi, or on a road after a taxi driver picks him/her up; and the driver device is more likely to appear on a road. Therefore, the identity information may also assist system 100 to train the neural network model, and may be included in the training parameters.

With reference back to FIG. 2, model generation unit 208 may generate a neural network model based on at least one set of training parameters. Each set of training parameters may be associated with one existing device. Model generation unit 208 may include a convolutional neural network (CNN) to train the neural network model based on the training parameters.

In some embodiments, the training parameters may at least include the benchmark position of the existing device, the hypothetical positions associated with the exiting device, the position values of the hypothetical positions, the training base map, and the identity information of the exiting device. The hypothetical positions and the position values of the hypothetical positions may be input to the CNN of model generation unit 208 as part of a training image. As discussed above, the training image may have a size of 100 pixels×100 pixels. The training base map may be similarly provided to the CNN as an image having a size of 100 pixels×100 pixels. The benchmark position may be used as a supervised signal for training the CNN.

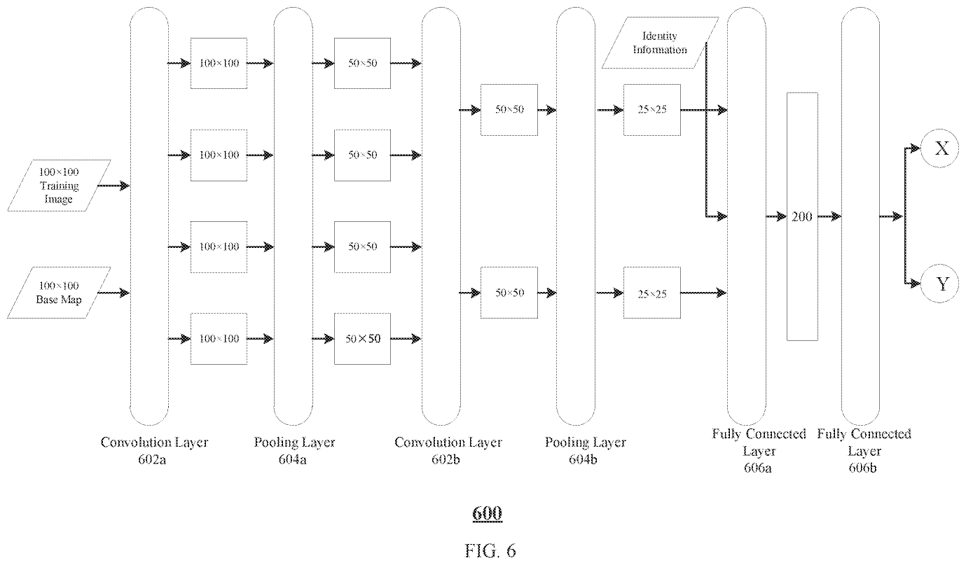

FIG. 6 illustrates an exemplary convolutional neural network, according to some embodiments of the disclosure.

In some embodiments, CNN 600 of model generation unit 208 includes one or more convolutional layers 602 (e.g. convolutional layers 602a and 602b in FIG. 6). Each convolutional layer 602 may have a plurality of parameters, such as the width (“W”) and height (“H”) determined by the upper input layer (e.g., the size of the input of convolutional layer 602a), and the number of filters or kernels (“N”) in the layer and their sizes. For example, the size of filters of convolutional layers 602a is 2×4, and the size of filters of convolutional layers 602b is 4×2. The size of filters may be referred to as the depth of the convolutional layer. The input of each convolutional layer 602 is convolved with one filter across its width and height and produces a new feature image corresponding to that filter. The convolution is performed for all filters of each convolutional layer, and the resulting feature images are stacked along the depth dimension. The output of a preceding convolutional layer can be used as input to the next convolutional layer.

In some embodiments, convolutional neural network 600 of model generation unit 208 may further include one or more pooling layers 604 (e.g. pooling layers 604a and 604b in FIG. 6). Pooling layer 604 can be added between two successive convolutional layers 602 in CNN 600. A pooling layer operates independently on every depth slice of the input (e.g., a feature image from a previous convolutional layer), and reduces its spatial dimension by performing a form of non-linear down-sampling. As shown in FIG. 6, the function of the pooling layers is to progressively reduce the spatial dimension of the extracted feature image to reduce the amount of parameters and computation in the network, and hence to also control overfitting. For example, the dimension of the feature image generated by convolutional layers 602a is 100×100, and the dimension of the feature image processed by pooling layer 604a is 50×50. The number and placement of the pooling layers may be determined based on various factors, such as the design of the convolutional network architecture, the size of the input, the size of convolutional layers 602, and/or application of CNN 600.

Various non-linear functions can be used to implement the pooling layers. For example, max pooling may be used. Max pooling may partition a feature image of the input into a set of overlapping or non-overlapping sub-regions with a predetermined stride. For each sub-region, max pooling outputs the maximum. This downsamples every feature image of the input along both its width and its height while the depth dimension remains unchanged. Other suitable functions may be used for implementing the pooling layers, such as average pooling or even L2-norm pooling.

As shown in FIG. 6, CNN may further include another set of convolutional layer 602b and pooling layer 604b. It is contemplated that more sets of convolutional layers and pooling layers may be provided.

As another non-limiting example, one or more fully-connected layers 606 (e.g. fully connected layers 606a and 606b in FIG. 6) may be added after the convolutional layers and/or the pooling layers. The fully-connected layers have a full connection with all feature images of the previous layer. For example, a fully-connected layer may take the output of the last convolutional layer or the last pooling layer as the input in vector form,.

For example, as shown in FIG. 6, two previously generated feature images of 25×25 and the identity information may be provided to fully-connected layer 606a, and a feature vector of 1×200 may be generated and further provided to fully-connected layer 606b. In some embodiments, the identity information may not be necessary.

The output vector of fully-connected layer 606b is a vector of 1×2, indicating estimated coordinates (X, Y) of the existing device. The goal of the training process is that output vector (X, Y) conforms to the supervised signal (i.e., the benchmark position of the existing device). The supervised signals are used as constraints to improve the accuracy of CNN 600.

As a further non-limiting example, a loss layer (not shown) may be included in CNN 600. The loss layer may be the last layer in CNN 600. During the training of CNN 600, the loss layer may determine how the network training penalizes the deviation between the predicted position and the benchmark position (i.e., the GPS position). The loss layer may be implemented by various suitable loss functions. For example, a Softmax function may be used as the final loss layer.

With reference back to FIG. 2, based on at least one set of training parameters, model generation unit 208 may generate a neural network model for positioning a terminal device. The generated neural network model may be stored to memory 212. Memory 212 may be implemented as any type of volatile or non-volatile memory devices, or a combination thereof, such as a static random access memory (SRAM), an electrically erasable programmable read- only memory (EEPROM), an erasable programmable read-only memory (EPROM), a programmable read-only memory (PROM), a read-only memory (ROM), a magnetic memory, a flash memory, or a magnetic or optical disk.

In the positioning stage, communicate interface 202 may acquire a set of preliminary positions associated with the terminal device. The preliminary positions indicate possible positions of access points scanned by the terminal device. Communicate interface 202 may also acquire a base map corresponding to the preliminary positions. The base map includes map information of the area corresponding to the preliminary positions.

Position determination unit 210 may determine a position of the terminal device using the generated neural network mode based on the preliminary positions and the base map.

In some embodiments, communicate interface 202 may further acquire identity information of the terminal device to assist positioning the terminal device. The identity information identifies that the terminal device is a passenger device or a driver device. Positions of a passenger device and a driver device may be associated with different, known features. For example, a driver device has to be on a drivable road, while a passenger device is usually indoor or on roadside. Therefore, identity information of the terminal device provides additional a priori information, and neural network model may further refine the positioning results based on the identify information.

Therefore, system 100 according embodiments of the disclosure may position a terminal device based on preliminary positions associated with the terminal device, using a deep learning neural network model.

In the above-described embodiments, the preliminary positions associated with the terminal device are treated as possible positions of the scanned APs. The assumption is that for the terminal device to be able to detect and scan the APs, the APs have to be located sufficiently close to the terminal device. In some embodiments, the preliminary positions may include other kinds of positions associated with the terminal device. For example, when a terminal device receives from a positioning server a set of preliminary positioning results of the terminal device generated based on the AP fingerprint, the preliminary positioning results may also be used to train the neural network model in the training stage or positioning the terminal device in the positioning stage. It is contemplated that, the preliminary positions associated with the terminal device may include any positions associated with the position of the terminal device.

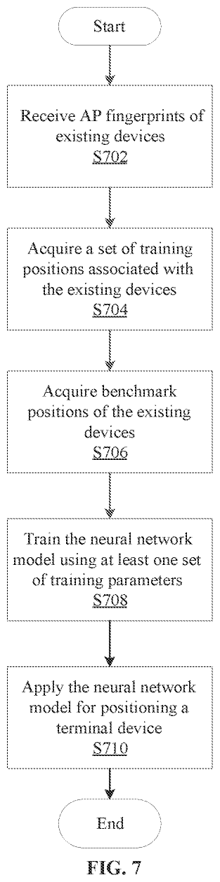

FIG. 7 is a flowchart of an exemplary process for positioning a terminal device, according to some embodiments of the disclosure. Process 700 may include steps S702-S710 as below.

Process 700 may include a training stage and a positioning stage. In the training stage, existing devices provide training parameters to the positioning device for training a neural network model. In the positioning stage, the neural network model may be used to position the terminal device. Process 700 may be performed by a single positioning device, such as system 100, or by multiple devices, such as the combination or system 100, terminal device 102, or positioning server 106. For example, the training stage may be performed by system 100, and the positioning stage may be performed by terminal device 102.

In step S702, the positioning device may receive AP fingerprints of existing devices. The AP fingerprints may be generated by the existing devices scanning nearby APs. Each terminal device 102 may generate an AP fingerprint. The AP fingerprint includes feature information associated with the scanned APs, such as identifications (e.g., names, MAC addresses, or the like), Received Signal Strength Indication (RSSI), Round Trip Time (RTT), or the like of APs 104.

In step S704, the positioning device may acquire a set of training positions associated with the existing devices. The training positions may include hypothetical positions for each AP scanned by the existing device. The hypothetical positions may be stored in a positioning server, and retrieved by the positioning device according to the AP fingerprint. Each AP may include more than one hypothetical positions.

In step S706, the positioning device may acquire benchmark positions of the existing devices. A benchmark position is a known position of the existing device. The benchmark position may be previously verified as conform to the true position of the existing device. In some embodiments, the benchmark position may be determined by GPS signals received by the existing device. The benchmark position may also be determined by other positioning methods, as long as the accuracy of the positioning results meets the predetermined requirements. For example, a benchmark position may be a current address provided by the user of the existing device.

In step S706, the positioning device may train the neural network model using at least one set of training parameters associated with the existing devices. The neural network model may be a convolutional neural network model. Consistent with embodiments of the disclosure, each set of training parameters may include a benchmark position of the existing device and a plurality of training positions associated with the existing device. The training positions may include, for example, the hypothetical positions of the scanned APs. As explained above, the training positions may include other positions associated with the benchmark position of the existing device. For example, the training positions may include possible positions of the existing device returned from a positioning server.

Each set of training parameters may further include a training base map determined according to the training positions, and identity information of the existing device. The training base map may be acquired from, for example, a map server, according to the hypothetical positions of the scanned APs. The training base map may include map information regarding roads, building, or the like in the area containing the training positions. The map information may assist the positioning device to train the neural network model. The identity information may identify that the existing device is a passenger device or a driver device.

Each set of training parameters may further include a position value corresponding to each training position. In some embodiments, as explained above, each AP may include more than one hypothetical positions, therefore hypothetical positions of the APs may overlap with each other. Thus, a position value may be assigned to each hypothetical position, and the position value may be incremented when the hypothetical positions overlap. For example, the position value may be incremented by one when a first hypothetical position of a first AP overlaps a second hypothetical position of a second AP.

Consistent with embodiments of the disclosure, a training image may be generated based on coordinates of the hypothetical positions and respective position values. The hypothetical positions may be mapped to pixels of the training image, and the positions values of the hypothetical positions may be converted to pixel values of the pixels.

Therefore, the training parameters may include the benchmark position of the existing device, the hypothetical positions associated with the exiting device, the position values of the hypothetical positions, the training base map, and the identity information of the exiting device. The benchmark position may be used as a supervised signal. Details of training the neural network model have been described with reference to FIG. 6.

After the neural network model is trained by the positioning device, in step S710, the neural network model may be applied for positioning a terminal device.

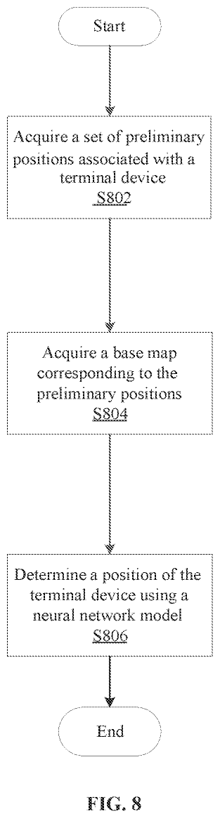

FIG. 8 is a flowchart of an exemplary process for positioning a terminal device using a neural network model, according to some embodiments of the disclosure. Process 800 may be implemented by the same positioning device that implements process 700 or a different positioning device, and may include steps S802-S806.

In step S802, the positioning device may acquire a set of preliminary positions associated with the terminal device. The preliminary positions in the positioning stage may be similarly acquired as the hypothetical positions in the training stage.

In step S804, the positioning device may acquire a base map corresponding to the preliminary positions. The base map in the positioning stage may be similarly acquired as the training base map in the training stage. The base map also includes map information regarding roads, building, or the like. Besides the base map, the positioning device may further acquire identity information of the terminal device.

In step S806, the positioning device may determine a position of the terminal device using the neural network model based on the preliminary positions and the base map. In some embodiments, the positioning device may position the terminal device using the neural network model based on the preliminary positions, the base map, and the identity information associated with the terminal device. In some embodiments, the neural network model may output estimated coordinates of the terminal device. In some other embodiments, the positioning device may further generate an image may be based on the estimated coordinates, and indicate the position of the terminal device on the image. For example, the position of the terminal device may be marked in the resulting image, such as by indicating its latitude and longitude.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed positioning system and related methods. Although the embodiments describe training a neural network model based on an image containing training parameters, it is contemplated that the image is merely an exemplary data structure of training parameters and any suitable data structure may be used as well.

It is intended that the specification and examples be considered as exemplary only, with a true scope being indicated by the following claims and their equivalents.

1. A computer-implemented method for positioning a terminal device, comprising:
acquiring, by a positioning device, a set of preliminary positions associated with the terminal device;
acquiring, by the positioning device, a base map corresponding to the preliminary positions associated with the terminal device; and
determining, by the positioning device, a position of the terminal device using a neural network model based on the preliminary positions associated with the terminal device and the base map.

2. The method of claim 1, further comprising training the neural network model using at least one set of training parameters.

3. The method of claim 2, wherein each set of the at least one set of training parameters comprises:
a benchmark position of an existing device; and
a plurality of training positions associated with the existing device.

4. The method of claim 3, wherein each set of the at least one set of training parameters further comprises:
a training base map determined according to the plurality of training positions associated with the existing device; and
identity information of the existing device, wherein
the training base map comprising information of buildings and roads.

5. The method of claim 3, wherein the plurality of training positions associated with the existing device comprise hypothetical positions for each access point (AP) scanned by the existing device.

6. The method of claim 5, wherein each set of the at least one set of training parameters further comprises a position value corresponding to each training position associated with the existing device, wherein
the position value corresponding to each training position of the plurality of training position is incremented when a first hypothetical position of a first AP overlaps a second hypothetical position of a second AP.

7. The method of claim 6, further comprising generating an image based on coordinates of the plurality of training positions associated with the existing device and the respective position values corresponding to the plurality of training positions.

8. The method of claim 7, wherein the plurality of training positions associated with the existing device are mapped to pixels of the image, and the position values corresponding to the plurality of training positions are converted to pixel values of the pixels.

9. The method of claim 4, wherein the identity information of the existing device identifies that the existing device is a passenger device or a driver device.

10. The method of claim 3, wherein the benchmark position is determined according to Global Positioning System (GPS) signals received by the existing device.

11. A system for positioning a terminal device, comprising:
a memory configured to store a neural network model;
a communication interface in communication with the terminal device and a positioning server, the communication interface configured to:
acquire a set of preliminary positions associated with the terminal device,
acquire a base map corresponding to the preliminary positions associated with the terminal device; and
a processor configured to determine a position of the terminal device using the neural network model based on the preliminary positions associated with the terminal device and the base map.

12. The system of claim 11, wherein the processor is further configured to train the neural network model using at least one set of training parameters.

13. The system of claim 12, wherein each set of the at least one set of training parameters comprises:
a benchmark position of an existing device; and
a plurality of training positions associated with the existing device.

14. The system of claim 13, wherein each set of the at least one set of training parameters further comprises:
a training base map determined according to the plurality of training positions associated with the existing device; and
identity information of the existing device, wherein
the training base map comprising information of buildings and roads.

15. The system of claim 13, wherein the plurality of training positions associated with the existing device comprise hypothetical positions for each access point (AP) scanned by the existing device.

16. The system of claim 15, wherein each set of the at least one set of training parameters further comprises a position value corresponding to each training position of the plurality of training positions, wherein
the position value corresponding to each training position is incremented when a first hypothetical position of a first AP overlaps a second hypothetical position of a second AP.

17. The system of claim 16, wherein the processor is further configured to generate an image based on coordinates of the plurality of training positions associated with the existing device and the respective position values corresponding to the plurality of training positions.

18. The system of claim 17, wherein the plurality of training positions associated with the existing device are mapped to pixels of the image, and the position values corresponding to the plurality of training positions are converted to pixel values of the pixels.

19. The system of claim 14, wherein the identity information of the existing device identifies that the existing device is a passenger device or a driver device.

20. A non-transitory computer-readable medium that stores a set of instructions, when executed by at least one processor of a positioning system, cause the positioning system to perform a method for positioning a terminal device, the method comprising:
acquiring a set of preliminary positions associated with the terminal device;
acquiring a base map corresponding to the preliminary positions associated with the terminal device; and
determining a position of the terminal device using a neural network model based on the preliminary positions associated with the terminal device and the base map, wherein
the neural network model is trained using at least one set of training parameters.
